(19) United States
(12) Patent Application Publication
(10) Pub. No.: US 2017/0140549 A1
(43) Pub. Date: May 18, 2017

(54) METHOD OF PERCEIVING 3D STRUCTURE FROM A PAIR OF IMAGES

(71) Applicant: Amiad GURMAN, Tel Aviv (IL)

(72) Inventor: Amiad GURMAN, Tel Aviv (IL)

(21) Appl. No.: 15/322,146

(22) PCT Filed: Jun. 30, 2015
(86) PCT No.: PCT/IL2015/050672

§ 371 Date: Dec. 26, 2016

(30) Foreign Application Priority Data
Jul. 3, 2014 (IL) 233518

(51) Int. Cl. G06T 7/593

(52) U.S. Cl. CPC G06T 7/593; G06T 2207/10012; G06T 2207/10028; G06T 2207/20016

(57) ABSTRACT

A method for perceiving a three-dimensional (3D) structure from a pair of original images, comprising the steps of: a) creating a pyramid for each one of the original images, wherein the pyramid is series of images each constituting a level of the pyramid and each having a half resolution in each dimension with respect to a previous level in the pyramid; b) performing CTF stereo matching on the pyramids of the pair of original images; c) detecting, in corresponding levels of the pair of original images, an anchor which (i) had a poor result in the CTF stereo matching, and (ii) has a high uniqueness score; and d) performing a full exhaustive disparity search on said anchor, and diffusing a solution of the search to neighborhood pixels of said anchor.

### CROSS-REFERENCE TO RELATED APPLICATIONS

This application claims the benefit of Israel Patent Application No. 233518, filed Jul. 3^{rd}, 2014, and entitled “A Method of Perceiving 3D Structure from a Pair of Images”, the contents of which are incorporated herein by reference in their entirety.

### FIELD OF THE INVENTION

The present invention relates to the field of stereo vision systems.

### BACKGROUND OF THE INVENTION

Stereo vision is an important step in order to perceive, visually, the three-dimensional (3D) structure of the world. The ability of perceiving 3D structure of the world is, in its turn, a key step in performing higher level of visual understanding. This is true for both biological visual systems, and computational vision devices. Yet, the gap between the two is enormous. While the problem is sufficiently solved in biological systems, the case is far from that in computer vision.

A number of different approaches can be followed to extract information on a 3D structure from one or more images of a scene. Computational stereo approaches generate depth estimates at some set of locations (or directions) relative to a reference frame. For two-camera approaches, these estimates are often given relative to the first camera's coordinate system. Sparse reconstruction systems generate depth estimates at a relatively small subset of possible locations, where dense reconstruction systems attempt to generate estimates for most or all pixels in the imagery.

Computational stereo techniques estimate a range metric such as depth by determining corresponding pixels in two images that show the same entity (scene object, element, location or point) in the 3D scene. Given a pair of corresponding pixels and knowledge of the relative position and orientation of the cameras, depth can be estimated by triangulation to find the intersecting point of the two camera rays. Once depth estimates are computed, knowledge of intrinsic and extrinsic camera parameters for the input image frame is used to compute equivalent 3D positions m an absolute reference frame (e.g., global positioning system (GPS) coordinates), thereby producing, for example, a 3D point cloud for each frame of imagery, which can be converted into surface models for further analysis using volumetric tools.

While it is “depth” which provides the intuitive difference between a 2D and a 3D image, it is not necessary to measure or estimate depth directly. “Disparity” is another range metric that is analytically equivalent to depth when other parameters are known. Disparity refers, generally, to the difference in pixel locations (i.e., row and column positions) between a pixel in one image and the corresponding pixel in another image. More precisely, a disparity vector stores the difference in pixel indices between matching pixels in a pair of images. If camera position and orientation are known for two frames being processed, then quantities such as correspondences, disparity, and depth hold equivalent information: depth can be calculated from disparity by triangulation.

A disparity vector field stores a disparity vector at each pixel, and thus tells how to find the match (or correspondences) for each pixel in the two images. When intrinsic and extrinsic camera parameters are known, triangulation converts those disparity estimates into depth estimates and thus 3D positions relative to the camera's frame of reference.

The basic process in dense computational stereo is to determine the correspondences between all the pixels in the two (or more) images being analyzed. This computation, which at its root is based on a measure of local match quality between pixels, remains a challenge, and accounts for the majority of complexity and runtime in computational stereo approaches.

The foregoing examples of the related art and limitations related therewith are intended to be illustrative and not exclusive. Other limitations of the related art will become apparent to those of skill in the art upon a reading of the specification and a study of the figures.

### SUMMARY OF THE INVENTION

The following embodiments and aspects thereof are described and illustrated in conjunction with systems, tools and methods which are meant to be exemplary and illustrative, not limiting in scope.

One embodiment provides a method for perceiving a three-dimensional (3D) structure from a pair of original images, comprising the steps of: a) creating a pyramid for each one of the original images, wherein the pyramid is series of images each constituting a level of the pyramid and each having a half resolution in each dimension with respect to a previous level in the pyramid; b) performing CTF stereo matching on the pyramids of the pair of original images; c) detecting, in corresponding levels of the pair of original images, an anchor which (i) had a poor result in the CTF stereo matching, and (ii) has a high uniqueness score; and d) performing a full exhaustive disparity search on said anchor, and diffusing a solution of the search to neighborhood pixels of said anchor.

Another embodiment provides computer program product for perceiving a three-dimensional (3D) structure from a pair of original images, the computer program product comprising a non-transient computer-readable storage medium having stored thereon instructions which, when executed by at least one hardware processor, cause the hardware processor to: a) create a pyramid for each one of the original images, wherein the pyramid is series of images each constituting a level of the pyramid and each having a half resolution in each dimension with respect to a previous level in the pyramid; b) perform CTF stereo matching on the pyramids of the pair of original images; c) detect, in corresponding levels of the pair of original images, an anchor which (i) had a poor result in the CTF stereo matching, and (ii) has a high uniqueness score; and d) perform a full exhaustive disparity search on said anchor, and diffuse a solution of the search to neighborhood pixels of said anchor.

A further embodiment provides a system comprising: at least two digital image sensors; a non-transient computer-readable storage medium having stored thereon instructions for: a) creating a pyramid for each one of the original images, wherein the pyramid is series of images each constituting a level of the pyramid and each having a half resolution in each dimension with respect to a previous level in the pyramid; b) performing CTF stereo matching on the pyramids of the pair of original images; c) detecting, in corresponding levels of the pair of original images, an anchor which (i) had a poor result in the CTF stereo matching, and (ii) has a high uniqueness score; and d) performing a full exhaustive disparity search on said anchor, and diffusing a solution of the search to neighborhood pixels of said anchor.

In some embodiments, the method further comprises applying Canny based Boolean mask for all the images in the series, and for each pixel, in all the images, aggregating the Boolean information from Canny, in its neighborhood, and compressing it into an integer or long integer, thereby providing a matching score (HCA) defined as a Hamming distance of the Canny Aggregate (CA) of matched pixels.

In some embodiments, the method further comprises creating an initial guess for disparity map in the lowest resolution by choosing a constant map with reasonable disparity for all the pixels, and applying a refinement on said map, such that each pixel looking for the disparities close to the initial guess and picking the one with the best HCA.

In some embodiments, the anchor detection includes: e) creating list of anchor candidates, wherein the candidates are pixels with low matching score (less than a certain threshold); f) classifying the detected anchor by separate these pixels into two lists: a first list is the pixels with neighbor whose score is high, and a second list is the pixels with no such neighbor; g) sorting the pixels in said two lists by order of their uniqueness measure, most distinctive pixels, first, wherein for this purpose, holding a separate map that count how many pixels are turned on in the CA map.

In some embodiments, on the two sorted lists performing the exhaustive search includes, first on the first list and after on the second list, wherein the anchors in the first list checks only few candidates, diffused from their good neighbors, and wherein the anchors from the second list will go through full range exhaustive search, such that a success in exhaustive search is when the best HCA is above predefines threshold.

In some embodiments, the method further comprises after each successful exhaustive search, starting diffusing its result, such that each pixel that get an initial guess from its neighbor as follows: h) scoring the initial guess disparity and near disparities by HCA; i) picking the disparities from step g) which have the best HCA; j) if the HCA of said each pixel is higher than a certain threshold, and higher than the score that already exists for said each pixel, due to other processes that visited this pixel already, updating the disparity to this pixel; k) upon finished with an update, diffusing the pixel to its neighbors; 1) if the pixel that got a good HCA, and is belong to any of the anchor lists, removing said pixel from these lists; m) upscaling the result to the higher resolution, wherein this upscale disparity map is the initial guess of the next resolution; and n) performing said process for each resolution, such that the result of is the final result for each resolution, then perform said upsacling if higher resolution is needed.

In some embodiments, the instructions are further executable by said at least one hardware processor for applying Canny based Boolean mask for all the images in the series, and for each pixel, in all the images, aggregating the Boolean information from Canny, in its neighborhood, and compressing it into an integer or long integer, thereby providing a matching score (HCA) defined as a Hamming distance of the Canny Aggregate (CA) of matched pixels.

In some embodiments, the instructions are further executable by said at least one hardware processor for creating an initial guess for disparity map in the lowest resolution by choosing a constant map with reasonable disparity for all the pixels, and applying a refinement on said map, such that each pixel looking for the disparities close to the initial guess and picking the one with the best HCA.

In some embodiments, the instructions are further executable by said at least one hardware processor, after each successful exhaustive search, for starting diffusing its result, such that each pixel that get an initial guess from its neighbor as follows: h) scoring the initial guess disparity and near disparities by HCA; i) picking the disparities from step g) which have the best HCA; j) if the HCA of said each pixel is higher than a certain threshold, and higher than the score that already exists for said each pixel, due to other processes that visited this pixel already, updating the disparity to this pixel; k) upon finished with an update, diffusing the pixel to its neighbors; 1) if the pixel that got a good HCA, and is belong to any of the anchor lists, removing said pixel from these lists; m) upscaling the result to the higher resolution, wherein this upscale disparity map is the initial guess of the next resolution; and n) performing said process for each resolution, such that the result of is the final result for each resolution, then perform said upsacling if higher resolution is needed.

In some embodiments, the instructions further comprise: applying Canny based Boolean mask for all the images in the series, and for each pixel, in all the images, aggregating the Boolean information from Canny, in its neighborhood, and compressing it into an integer or long integer, thereby providing a matching score (HCA) defined as a Hamming distance of the Canny Aggregate (CA) of matched pixels.

In some embodiments, the instructions further comprise: creating an initial guess for disparity map in the lowest resolution by choosing a constant map with reasonable disparity for all the pixels, and applying a refinement on said map, such that each pixel looking for the disparities close to the initial guess and picking the one with the best HCA.

In addition to the exemplary aspects and embodiments described above, further aspects and embodiments will become apparent by reference to the figures and by study of the following detailed description.

### BRIEF DESCRIPTION OF TIlE DRAWINGS

Exemplary embodiments are illustrated in referenced figures. Dimensions of components and features shown in the figures are generally chosen for convenience and clarity of presentation and are not necessarily shown to scale. The figures are listed below.

FIG. 1 is a flowchart illustrating an exemplary method for fitting the computational load to the complexity of the scene, according to an embodiment; and

FIG. 2 is a block diagram of a system for machine stereo vision, according to an embodiment.

### DETAILED DESCRIPTION

Disclosed herein is a method, system and computer program product for machine stereo vision, in which a 3D structure is perceived from a pair of original images. Advantageously, the computational load required for this machine stereo vision is fitted to the complexity of the scene depicted in the images, thereby conserving computational resources such as processor usage, memory usage and/or power consumption.

An important insight in solving complex problem such as stereo vision, is that not all the data in the images demands uniform level of computational load. Objects that are both structural smooth and heavily textured, such as wood boards, detailed shirts etc. are much easier to solve, stereo vision wise, than non-textured walls or high detailed structures such as cogwheels, human palms or curly hairs.

A refinement to this insight is a heurist quantification of it. The assumption herein is that most of the data need a relatively low level of computational effort. It is assumed that roughly, about 90% of the data is such. The significant parts of the images, both in terms of required accuracy for higher level visual understanding and in terms of computational complexity, oftentimes capture less than 10% of the pixels in each image.

The common solution to find stereo matching in a pair of images is to find, for each pixel's neighborhood in one image, the best matching in the other image, out of all theoretical possibilities, without any prior. This leads to complexity of N*M, where N is the number of pixels and M is the disparity range. The method of estimating disparity of a pixel from scratch, without any priors, is referred to herein as Exhaustive Search.

A more efficient and advanced method, in accordance with present embodiments, is to detect candidates for the exhaustive search, as first stage. Each such candidate that the exhaustive search found a good matching for (according to some matching criteria, such as Sum the Square Difference (SSD) between matching pixels in a ROI around or in the neighborhood of the pixels), is called an “anchor”. The second stage is to diffuse the disparity of the anchor to neighboring pixels with some tolerance that comes from the smoothness prior. In such a way, use of the expensive exhaustive search algorithm is narrowed to a small amount of pixels, and evaluation of a much smaller amount of candidates for the rest of the pixels is needed, relying on a smoothness prior. This method is referred to herein as Exhaustive and Diffusion (E&D).

An anchor needs to have a unique shape and orientation in order to increase the probability to find a unique matching in the second image.

We know that we are going to run an “expensive” algorithm on an anchor (i.e., that can consume considerable amounts of memory and other system resources), so let us maximize its probability to succeed. For uniqueness measure, present embodiments may utilize one of the many methods available, such as Harris points (see C. Harris and M. Stephens (1988). “A combined corner and edge detector”. Proceedings of the 4th Alvey Vision Conference. pp. 147-151), SIFT (see Lowe, David G. (1999). “Object recognition from local scale-invariant features”. Proceedings of the International Conference on Computer Vision 2. pp. 1150-1157) and SURF (see Herbert Bay, Andreas Ess, Tinne Tuytelaars, Luc Van Gool, (2008) “SURF: Speeded Up Robust Features”, Computer Vision and Image Understanding (CVIU), Vol. 110, No. 3, pp. 346-359).

The problem is that the anchors need to be distributed in such a way, that no isolated object will be missed. An isolated object is an object that has significantly different depth from its environment. Such an object will not get the right disparity through the diffusion algorithm. Therefore, present embodiments should select one of its pixels as an anchor. This distribution requirement leads to minimal amount required anchors, which can be big.

Another method, known for its efficiency, is coarse-to-fine (CTF). The method constructs hierarchical pyramids for each one of the two original images. A pyramid is a series of images, each with half resolution of the previous image. Then, the method applies a matching algorithm to the lowest resolution, which is relatively fast because the image and the possible disparity number of candidates, are very small. An exemplary matching method is described in further details hereinafter. The refinement step is to use the solution for each resolution as an initial guess for the higher resolution, and refine it. In that way, only two or three candidate for each pixel in each resolution will be obtained. This leads to a logarithmic ratio between the performance and the resolution. The problem of this method is that it gives low quality on fine details that we could not reveal in the lowest resolution. Still, it gives good solution on the majority of the pixels.

The inspirations provided by the techniques described hereinabove are combined in the embodiments described herein in a new way to yield an approach with particular advantages. Therefore, present embodiments use the above E&D and CTF methods as complementary to each other. Given that we performed CTF, we assume that the pixels that belong to objects that we missed will have poor matching score. Out of these pixels the method chooses the pixels with the highest uniqueness measure, and runs exhaustive search on them. If it succeeds, the method diffuses their disparity, until the score does not improve the existing one (from CTF). We can look on this combination in two ways:

1. E&D as the main algorithm, and CTF as its detector for anchors.

2. CTF as main algorithm, and E&D as an error correction.

This combination implements the above insight in a simple and elegant way. Most of the pixels will have the right solution in very efficient way (CTF), while the problematic ones will be automatically detected and then handled in a more expensive and thorough way. Using this combined approach to gain the benefits of both techniques, therefore, represents a non-obvious extension of the state of the art.

Computational stereo vision estimates depth by determining corresponding pixels in two images that show the same point in the 3D scene and exploiting the epipolar geometry to compute depth. Given a pair of corresponding pixels and knowledge of the relative position and orientation of the cameras, depth can be estimated by triangulation to find the intersecting point of the two camera rays. Computational stereo vision approaches are based on triangulation of corresponding pixels, features, or regions within an epipolar geometry between two cameras. Triangulation is straightforward under certain stereo geometries and in the absence of errors in the correspondence estimate.

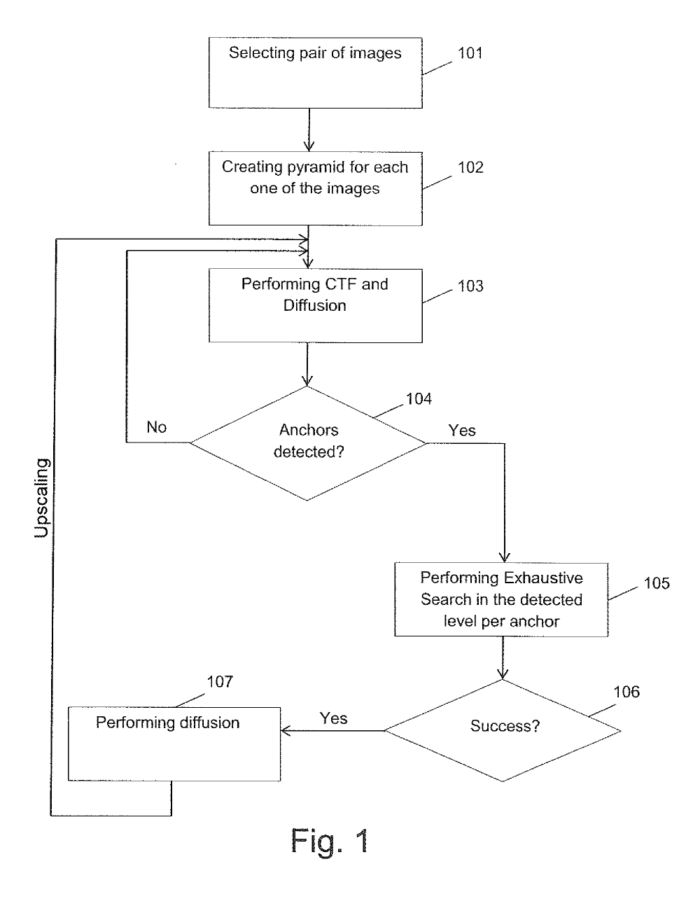

FIG. 1 is a flowchart illustrating an exemplary method for fitting the computational load to the complexity of the scene, according to an embodiment of the invention. In a block 101, a pair of images I₁(i,j) and I₂(i,j) (where I=1,2 , . . . , imax and j=1,2 , . . . , jmax are discrete pixel indices) are selected for stereo processing (e.g., from a video stream). In a block 102, the method creates a pyramid for each one of the images, wherein each pyramid is a series of images having different resolutions: each level in the pyramid is an image having half resolution in each dimension, than the image in the previous level of the pyramid.

An intermediate step may be added: After a CTF refinement, we detect anchors, with a relatively low matching score, and high uniqueness measure, whose neighbors are pixels with a relatively high matching score. These pixels represent, in most cases, edges and holes in a refined disparity map. For such anchors, we will estimate only disparity candidates that we would have diffused from the good neighbor's disparity. In such a way, we use the E&D algorithm on edges and holes, but in a much more efficient way. We can view this step as a diffuser only. We start from anchors which are pixels with a relatively high matching score from the CTF, and which have at least one neighbor with a relatively low matching score and high distinction, and diffuse their disparity.

According to an embodiment, CTF and E&D are combined in each pyramid level separately. In a block 103, the method performs CTF and then diffusion from high to low score. In a block 104, the method detects anchors for E&D in each pyramid level. In a block 105, the method performs Exhaustive Search in the detected level per anchor. This way, the method exploits the exhaustive search in a very efficient way.

This will be better understood through the following illustrative and non-limitative example: Let us take for example, a palm in front of some background and let us assume that we missed it in the lowest resolution, and it contains 20×20 pixels in the highest resolution. We will detect our miss fax sooner than in the highest resolution stage. The moment the system detects the miss, it performs the exhaustive search (block 105). That way, we perform it with much lower number of candidates that we would do in the highest resolution. If this process succeeded (block 106), from now on we will only have to refine the palm in a higher resolution, and not finding it from scratch. This can be done by performing diffusion (block 107). In this embodiment, the diffusion is obtained by upscaling the pixels that define the palm (x, y, diffusion). This example demonstrates how the method automatically fits, tightly, the computational load to the complexity of the scene.

Advantageously, the method described hereinabove compensates the main disadvantage of CTF by equipping it with a robust and simple error correction for small and isolated details. Moreover, it compensates the main disadvantage of E&D by equipping it with an efficient detector for anchors.

The scoring referred to above is now discussed in further detail.

Today's straightforward known score for matching between pixels in two images, is to compare the intensities of their neighborhood, i.e. to sum the absolute value (or square) of the difference between corresponding pixels in the two neighborhoods. We call this method SSD (Sum of Square Differences. We share this name with the Sum of Absolute Values, for simplicity). The main disadvantages of this method are as follow: “Sensitivity to outliers”: Few pixels with outlying intensities can deteriorate the liability of the score un-proportionally. Such outliers can come from two main reasons: A. Hardware (camera etc.) error, B. The center pixel of the neighborhood is close to structural edge in the scene. Hench the matching score collects data from two regions, with different disparity. “Sensitivity to Appearance”: The intensity of the two windows (the neighborhoods of each pixel) can be very different from each other due to difference in illumination, reflection and/or point of view.

“Computational complexity”: Computational complexity is high since, typically, a dozen or more operations need to be performed for each and every pixel.

One of the most robust ways known today to overcome “Sensitivity to outliers” is to clamp the absolute value of difference by a certain threshold. Another robust way is to replace the difference, only by a Boolean answering the question if the difference is bigger than a certain threshold or not. The sums of this two suggested (per pixel) score within the neighboring windows, are analogues to MSAC (M-estimator Sample and Consensus, see P. H. S. Torr, A. Zisserman (2000), “MLESAC: A New Robust Estimator with Application to Estimating Image Geometry”, Computer Vision and Image Understanding 78, 138-156) and RANSAC (RANdom SAmple Consensus, see Robust Statistics, Peter. J. Huber, Wiley, 1981), accordingly. The second one is more basic. In RANSAC, we simply count outliers. It is easy to see why we do the same here with the Boolean method. In MSAC, we count outliers as equal to the threshold, and the inliers with their own value.

Another state-of-the art method to overcome “Sensitivity to Appearance” is to use normalized cross correlation. In this method, we subtract the average intensity from each neighborhood, perform inner product between the fixed values, and normalize the result by dividing it with the product of the neighborhoods L2 norms. This method is known as state of the art, in terms of robustness to appearance differences, but suffers from the same problem as “Sensitivity to outliers”, and it is even less efficient than SSD.

Another state of the art method, which overcomes all three disadvantages, is “Census” score. For a given pixel X0, with intensity I0 and neighborhood A, a window of Booleans is created, with same size of the original neighborhood, where the pixel “i” is the answer to the question whether the intensity Ii of pixel “i”, in the original neighborhood is bigger from 10. Then, this neighborhood of Booleans is compressed into integer or long64, and the Census score will be the hamming distance between two integers. It is easy to see the efficiency of this score.

The reason it is robust to outliers is it does the same to outliers as the robust versions of SSD (mentioned above) do. They are all limiting the weights of outliers. The reason why Census score tackles elegantly the sensitivity to appearance is that the information it holds, depends only on intensities relations within the image. These relations assumed to be preserved from image to image, even after changes in illumination.

We see two main disadvantages in the Census score:

1. It holds very little information about the neighborhood of X0. It holds no information about mutual relations between couples of pixels that do not contain X0.

2. It has unproportional dependency on 10, the intensity in X0.

The method of the present embodiments suggests an advantageous scoring calculation process that overcomes all the issues mentioned hereinabove. The process may involve the following steps:

applying an edge detection algorithm (e.g., the Canny algorithm) in order to get Boolean map of pixel representing edges; and

compressing it and calculating hamming distance, in the same way Census does.

This method limits the weight of outliers, in the same ways, all the robust methods, mentioned above, do. It is robust to illumination changes in the same level canny algorithm do. The Canny algorithm (see Canny, J., (1986) “A Computational Approach To Edge Detection”, IEEE Trans. Pattern Analysis and Machine Intelligence, 8(6):679-698) is known as having state of the art robustness to outlier and illumination changes. In addition, this score contains much more information than Census does, and gives uniform weight to the entire neighborhood, not as Census.

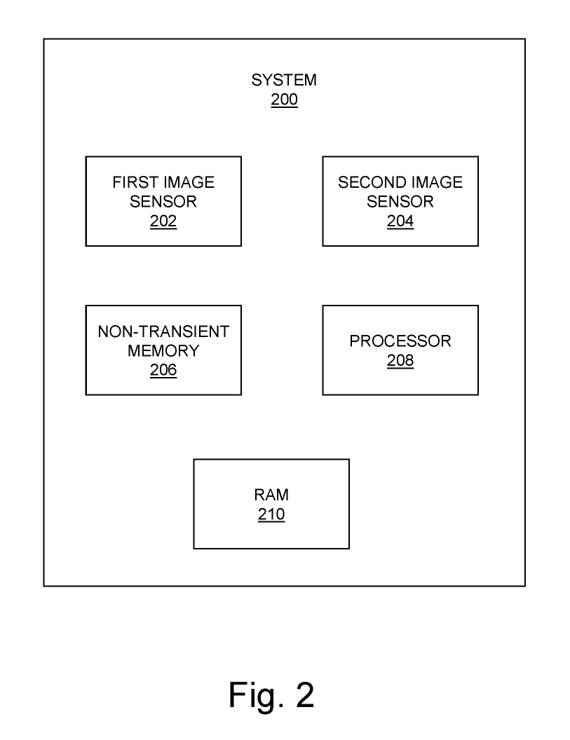

Reference is now made to FIG. 2, which shows a block diagram of a system 200 for machine stereo vision, in which a 3D structure is perceived from a pair of original images. System 200 may include at least two digital image sensors 202, 204. Examples of suitable image sensors include CCD (Charge-Coupled Device) and/or CMOS (Complementary Metal Oxide Semiconductor) devices, as known in the art. Sensors 202, 204 may be included in a single camera device or in separate camera devices.

System 200 may further include a non-transient computer-readable storage medium (“memory”) 206, such as a magnetic hard-drive, a flash memory device and/or the like, storing program instructions that implement the embodiments discussed above.

System 200 may further include at least one hardware processor 208 capable of executing the program instructions stored in memory 206. A random access memory (RAM) 210 may be also included in system 200, and be used as a temporary, fast storage for at least a portion of the instruction.

System 200, as one example, may be part of a robot. System 200 may endow the robot with stereoscopic machine vision capabilities which are needed to perform its duties.

Present embodiments may also be a computer program product. The computer program product may include a computer readable storage medium (or media) having computer readable program instructions thereon for causing a processor to carry out aspects of the present invention.

The computer readable storage medium can be a non-transitory, tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, or any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention may be described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for perceiving a three-dimensional (3D) structure from a pair of original images, comprising the steps of:
a) creating a pyramid for each one of the original images, wherein the pyramid is series of images each constituting a level of the pyramid and each having a half resolution in each dimension with respect to a previous level in the pyramid;
b) performing CTF stereo matching on the pyramids of the pair of original images;
c) detecting, in corresponding levels of the pair of original images, an anchor which (i) had a poor result in the CTF stereo matching, and (ii) has a high uniqueness score; and
d) performing a full exhaustive disparity search on said anchor, and diffusing a solution of the search to neighborhood pixels of said anchor.

2. The method according to claim 1, further comprising applying Canny based. Boolean mask for all the images in the series, and for each pixel, in all the images, aggregating the Boolean information from Canny, in its neighborhood, and compressing it into an integer or long integer, thereby providing a matching score (HCA) defined as a Hamming distance of the Canny Aggregate (CA) of matched pixels.

3. The method according to claim 2, further comprising creating an initial guess for disparity map in the lowest resolution by choosing a constant map with reasonable disparity for all the pixels, and applying a refinement on said map, such that each pixel looking for the disparities close to the initial guess and picking the one with the best HCA.

4. The method according to claim 1, wherein the anchor detection includes:
e) creating list of anchor candidates, wherein the candidates are pixels with low matching score (less than a certain threshold);
f) classifying the detected anchor by separate these pixels into two lists: a first list is the pixels with neighbor whose score is high, and a second list is the pixels with no such neighbor;
g) sorting the pixels in said two lists by order of their uniqueness measure, most distinctive pixels, first, wherein for this purpose, holding a separate map that count how many pixels are turned on in the CA map.

5. The method according to claim 4, wherein on the two sorted lists performing the exhaustive search includes, first on the first list and after on the second list, wherein the anchors in the first list checks only few candidates, diffused from their good neighbors, and wherein the anchors from the second list will go through range exhaustive search, such that a success in exhaustive search is when the best HCA is above predefines threshold.

6. The method according to claim 5, further comprising after each successful exhaustive search, starting diffusing its result, such that each pixel that get an initial guess disparity from its neighbor as follows:
h) scoring the initial guess disparity and near disparities by HCA;
i) picking the disparities from step g) which have the best HCA;
j) if the HCA of said each pixel is higher than a certain threshold, and higher than the score that already exists for said each pixel, due to other processes that visited this pixel already, updating the disparity to this pixel;
k) upon finished with an update, diffusing the pixel to its neighbors;
l) if the pixel that got a good HCA, and is belong to any of the anchor lists, removing said pixel from these lists;
m) upscaling the result to the higher resolution, wherein this upscale disparity map is the initial guess of the next resolution; and
n) performing said process for each resolution, such that the result of is the final result for each resolution, then perform said upsacling if higher resolution is needed.

7. A computer program product for perceiving a three-dimensional (3D) structure from a pair of original images, the computer program product comprising a non-transient computer-readable storage medium having stored thereon instructions which, when executed by at least one hardware processor, cause the hardware processor to:
a) create a pyramid for each one of the original images, wherein the pyramid is series of images each constituting a level of the pyramid and each having a half resolution in each dimension with respect to a previous level in the pyramid;
b) perform CTF stereo matching on the pyramids of the pair of original images;
c) detect, in corresponding levels of the pair of original images, an anchor which (i) had a poor result in the CTF stereo matching, and (ii) has a high uniqueness score; and
d) perform a full exhaustive disparity search on said anchor, and diffuse a solution of the search to neighborhood pixels of said anchor.

8. The computer program product according to claim 7, wherein the instructions are further executable by said at least one hardware processor for applying Canny based Boolean mask for all the images in the series, and for each pixel, in all the images, aggregating the Boolean information from Canny, in its neighborhood, and compressing it into an integer or long integer, thereby providing a matching score (HCA) defined as a Hamming distance of the Canny Aggregate (CA) of matched pixels.

9. The computer program product according to claim 7, wherein the instructions are further executable by said at least one hardware processor for creating an initial guess for disparity map in the lowest resolution by choosing a constant map with reasonable disparity for all the pixels, and applying a refinement on said map, such that each pixel looking for the disparities close to the initial guess and picking the one with the best HCA.

10. The computer program product according to claim 7, wherein the anchor detection includes:
e) creating list of anchor candidates, wherein the candidates are pixels with low matching score (less than a certain threshold);
f) classifying the detected anchor by separate these pixels into two lists: a first list is the pixels with neighbor whose score is high, and a second list is the pixels with no such neighbor;
g) sorting the pixels in said two lists by order of their uniqueness measure, most distinctive pixels, first, wherein for this purpose, holding a separate map that count how many pixels are turned on in the CA map.

11. The computer program product according to claim 10, wherein on the two sorted lists performing the exhaustive search includes, first on the first list and after on the second list, wherein the anchors in the first list checks only few candidates, diffused from their good neighbors, and wherein the anchors from the second list will go through full range exhaustive search, such that a success in exhaustive search is when the best HCA is above predefines threshold.

12. The computer program product according to claim 11, wherein the instructions are further executable by said at least one hardware processor, after each successful exhaustive search, for starting diffusing its result, such that each pixel that get an initial guess from its neighbor as follows:
h) scoring the initial guess disparity and near disparities by HCA;
i) picking the disparities from step g) which have the best HCA;
j) if the HCA of said each pixel is higher than a certain threshold, and higher than the score that already exists for said each pixel, due to other processes that visited this pixel already, updating the disparity to this pixel;
k) upon finished with an update, diffusing the pixel to its neighbors;
l) if the pixel that got a good HCA, and is belong to any of the anchor lists, removing said pixel from these lists;
m) upscaling the result to the higher resolution, wherein this upscale disparity map is the initial guess of the next resolution; and
n) performing said process for each resolution, such that the result of is the final result for each resolution, then perform said upsacling if higher resolution is needed.

13. A system comprising:
at least two digital image sensors;
a non-transient computer-readable storage medium having stored thereon instructions for:
a) creating a pyramid for each one of the original images, wherein the pyramid is series of images each constituting a level of the pyramid and each having a half resolution in each dimension with respect to a previous level in the pyramid;
b) performing CTF stereo matching on the pyramids of the pair of original images;
c) detecting, in corresponding levels of the pair of original images, an anchor which (i) had a poor result in the CTF stereo matching, and (ii) has a high uniqueness score; and
d) performing a full exhaustive disparity search on said anchor, and diffusing a solution of the search to neighborhood pixels of said anchor.
at least one hardware processor configured to execute said instructions.

14. The system according to claim 13, wherein the instructions further comprise:
applying Canny based Boolean mask for all the images in the series, and for each pixel, in all the images, aggregating the Boolean information from Canny, in its neighborhood, and compressing it into an integer or long integer, thereby providing a matching score (HCA) defined as a Hamming distance of the Canny Aggregate (CA) of matched pixels.

15. The system according to claim 13, wherein the instructions further comprise:
creating an initial guess for disparity map in the lowest resolution by choosing a constant map with reasonable disparity for all the pixels, and applying a refinement on said map, such that each pixel looking for the disparities close to the initial guess and picking the one with the best HCA.

16. The system according to claim 13, wherein the anchor detection includes:
e) creating list of anchor candidates, wherein the candidates are pixels with low matching score (less than a certain threshold);
f) classifying the detected anchor by separate these pixels into two lists: a first list is the pixels with neighbor whose score is high, and a second list is the pixels with no such neighbor;
g) sorting the pixels in said two lists by order of their uniqueness measure, most distinctive pixels, first, wherein for this purpose, holding a separate map that count how many pixels are turned on in the CA map.

17. The system according to claim 16, wherein on the two sorted lists performing the exhaustive search includes, first on the first list and after on the second list, wherein the anchors in the first list checks only few candidates, diffused from their good neighbors, and wherein the anchors from the second list will go through full range exhaustive search, such that a success in exhaustive search is when the best HCA is above predefines threshold.

18. The system according to claim 17, wherein the instructions further comprise, after each successful exhaustive search, starting diffusing its result, such that each pixel that get an initial guess from its neighbor as follows:
h) scoring the initial guess disparity and near disparities by HCA;
i) picking the disparities from step g) which have the best HCA;
j) if the HCA of said each pixel is higher than a certain threshold, and higher than the score that already exists for said each pixel, due to other processes that visited this pixel already, updating the disparity to this pixel;
k) upon finished with an update, diffusing the pixel to its neighbors;
l) if the pixel that got a good HCA, and is belong to any of the anchor lists, removing said pixel from these lists;
m) upscaling the result to the higher resolution, wherein this upscale disparity map is the initial guess of the next resolution; and
n) performing said process for each resolution, such that the result of is the final result for each resolution, then perform said upsacling if higher resolution is needed.
